(19) United States
(12) Patent Application Publication
(10) Pub. No.: US 2018/0184741 A1
(43) Pub. Date: Jul. 5, 2018

(54) CONVERTIBLE HEADGEAR AND PET BOWL

(71) Applicant: ANNA AZADA SAVILLO, Valencia, CA (US)

(72) Inventor: ANNA AZADA SAVILLO, Valencia, CA (US)

(21) Appl. No.: 15/394,446

(22) Filed: Dec. 29, 2016

(51) Int. Cl. A42B 1/00; A42B 1/06; A01K 5/01; A01K 7/00

(52) U.S. Cl. CPC A42B 1/006; A01K 7/00; A01K 5/0107; A42B 1/062

(57) ABSTRACT

A convertible headgear that can be converted to a bowl for holding liquid or solid, comprising: a crown formed of flexible, impermeable material and having a peripheral edge defining a head-receiving opening; a visor attached to the crown along a section of the peripheral edge and projecting forwardly from the crown; a stiffener installed inside the crown and situated below the peripheral edge of the crown and defining a head-receiving opening, where stiffener reinforces and retains the shape of a bowl when the crown member is pressed down, whereby the headgear is converted into a bowl for holding liquid or solid.

### FIELD OF THE INVENTION

This present invention generally relates to a convertible headgear which transforms into a bowl for holding drinks or food for pets, and is especially useful while doing outdoor activities.

### BACKGROUND OF THE INVENTION

Most pet owners bring their pets when they do outdoor activities such as hiking and walking in different places like parks, mountains, markets and malls. In these outdoor activities, pet owners usually bring a bottle of water for themselves and another bottle of water and a bowl for the pet to drink from. Bringing a bowl and an extra bottle of water for your pet can be heavy and an inconvenience when you are walking, especially in long distances or uphill.

When outdoors, the pet owner would have to bring a bowl for the pet, from which the pet can drink or eat. This would be an extra thing that the pet owner has to bring aside from the usual things necessary when you take your pet out. It is inconvenient and a hassle to have to bring a bowl every time you take your pet out. It is specially cumbersome when doing outdoor activities such as hiking or jogging.

There are a number of travel pet bowls currently available in the market, most of which can be characterized as having deformable or foldable side and bottom portion with variable surface and volume dimensions. There is U.S. Pat. No. 7,878,148. (PET DISH HAVING AN EXTENDED THREADED NECK RING AND SCREW-CAP LID). Another is U.S. Pat. No. 8,109,234 (COLLAPSIBLE PET BOWL). All of them can be used for holding liquid or solid. While all available pet bowls are satisfactory in performing their intended function, these items are not convertible headgear for holding liquid or solid unlike the present invention.

### SUMMARY AND OBJECT OF THE INVENTION

The present invention is directed to a headgear that can be converted into a bowl for holding for drinks or food for pets.

It is an object of the present invention to provide a convertible headgear that can be converted and used as a pet bowl for holding liquid or solid, comprising: a crown formed of flexible and impermeable material, having a peripheral edge defining a head-receiving opening; a visor attached to the crown along a section of the peripheral edge and projecting forwardly from the crown; a stiffener installed inside the crown and situated below the peripheral edge of the crown and defining a head-receiving opening, where stiffener will reinforce to retain the shape of a bowl when the crown member is pressed down, whereby the headgear is converted into a bowl for holding liquid or solid.

Other objects of the present invention will become apparent from reading the following description of the present invention, taken in conjunction with the accompanying drawings.

### BRIEF DESCRIPTION OF THE DRAWINGS

FIG. 1 is the perspective view of a convertible headgear as embodied in the present invention;

FIG. 2 is a rear perspective view of a convertible headgear showing the stiffener installed inside the crown as embodied in the present invention; and

FIG. 3 shows a headgear converted to a bowl for holding liquid or solid as embodied in the present invention.

### DETAILED DESCRIPTION OF THE INVENTION

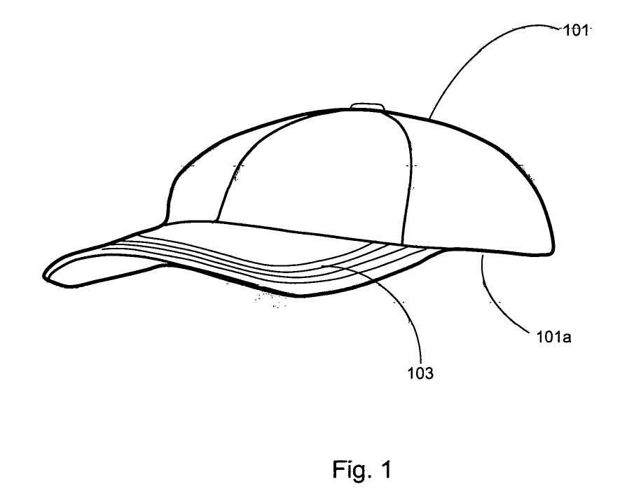

Referring to FIG. 1 of the present invention, there is shown a convertible headgear which comprises a crown member 101 and visor member 103. The crown member 101 is made of impermeable material capable to hold liquid or solid. A crown member 101 is having a peripheral edge defining a head-receiving opening 101a. A visor 103 is attached to the crown member 101 along a section of the peripheral edge and projecting forwardly from the crown member 101. A stiffener 201 installed inside the crown member 101 and situated below the peripheral edge of the crown member 101 and defining a head-receiving opening. The purpose of the stiffener 201 is to reinforce to retain the shape of the headgear when the crown member 101 is pressed down, whereby the headgear is converted into a bowl for holding liquid or solid.

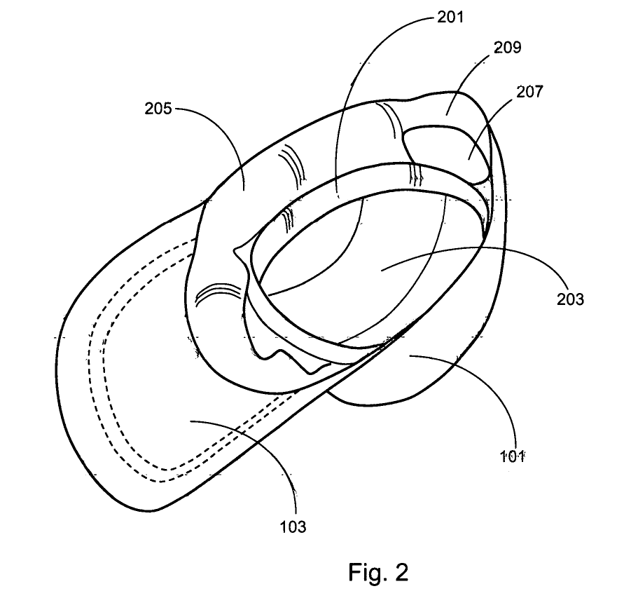

Referring to FIG. 2 of the present invention, there is shown a convertible headgear showing the stiffener 201 installed inside the crown. The stiffener 201 is situated around the bottom 203 mid-section and below the inner peripheral edge 205 of the crown member 101. The stiffener 201 is made of pliable material capable to reinforce to retain the shape of the crown member 101 if press to convert to a bowl for holding liquid or solid. As shown in FIG. 2, the stiffener 201 is situated below the opening 207. The member 209 is made of any material and intended as a locking means for purposes of adjustment to fit the headgear on the user's head.

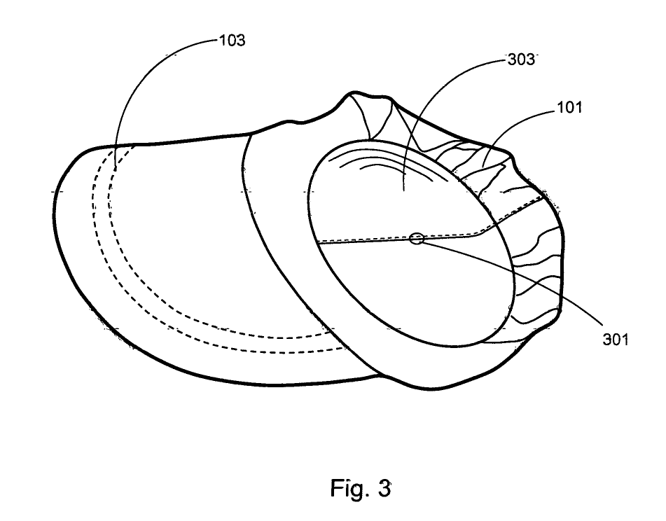

As shown in FIG. 3, it shows a headgear converted to a bowl for holding liquid or solid as embodied in the present invention. In FIG. 3, the crown member 101 is pressed down and is converted to a bowl. Once the crown member 101 is pressed down at the top portion thereof, the peripheral edge of which is guided by the stiffener 201 situated at the bottom mid-section of said crown member 101. to reinforce the shape of a bowl for holding liquid or solid. The converted headgear as shown in FIG. 3 is filled with water 303. There is also shown a button 301 situated in the middle outer portion of the crown member 101. The convertible headgear may or may not include a button 301 at the middle outer portion of the crown member 101 depending on the manufactures' desire.

When the pet is done drinking or eating from it, the user may push back the crown member 101 from the inside to return the converted headgear to its original shape as headgear. The user may put the headgear back on and continue his outdoor activities, e.g., jogging or walking.

With the foregoing description, it should be understood that these description are only by way of example and not intended to limit the scope of the invention. The scope of the embodiments should be determined by the appended claims and their legal equivalent, rather than by the example given.

What is claimed is:

1. A convertible headgear that can be converted to a bowl for holding liquid or solid, comprising:
a crown formed of impermeable material and having a peripheral edge defining a head-receiving opening;
a visor attached to the crown along a section of the peripheral edge and projecting forwardly from the crown;
a stiffener installed inside the crown and situated below the peripheral edge of the crown and defining a head-receiving opening, said stiffener reinforces and retains the shape of a bowl when the crown member is pressed down, whereby the headgear is converted into a bowl for holding liquid or solid.

2. A convertible headgear that can be converted to a bowl for holding liquid or solid according to claim 1 wherein the stiffener made of flexible material is located inside the bottom midsection of the crown member.

3. A convertible headgear that can be converted to a bowl for holding liquid or solid according to claim 1, wherein said bowl returns to a headgear when the bottom portion of the crown member is pushed above.
